(19) United States
(12) Patent Application Publication
(10) Pub. No.: US 2009/0150338 A1
(43) Pub. Date: Jun. 11, 2009

(54) POLICY DRIVEN MEMORY MANAGEMENT OF POOL OF CURSORS IN DATABASE MANAGEMENT SYSTEM

(75) Inventors: Scott Forstie, Rochester, MN (US); Shannon Everett Wenzel, Colby, WI (US)

Correspondence Address: WOOD, HERRON & EVANS, L.L.P. (IBM), 2700 CAREW TOWER, 441 VINE STREET, CINCINNATI, OH, 45202, US

(73) Assignee: INTERNATIONAL BUSINESS MACHINES CORPORATION, Armonk, NY (US)

(21) Appl. No.: 11/954,168

(22) Filed: Dec. 11, 2007

(51) Int. Cl. G06F 17/30

(52) U.S. Cl. 707/2; 707/E17.135

(57) ABSTRACT

An apparatus, program product and method utilize policy-driven management of a pool of cursors in a database management system. Cursor usage statistics are determined for a plurality of cursors, and a plurality of cursor criteria defined in a policy are used to identify one or more cursors to close based upon the determined statistics. Among the statistics that are collected is a query time statistic that specifies, for each cursor, how long the query with which that cursor is associated, took to execute. As a result, a cursor that is associated with query that took a relatively longer time to execute will generally be less likely to be closed than a cursor that is associated with a query that took a relatively shorter time to execute. Consequently, should a cursor be needed for a particular query after the cursor has been closed, the performance penalty associated with recreating that cursor and its associated objects will be reduced.

### FIELD OF THE INVENTION

The invention is generally related to computers and computer software, and in particular, to database management systems and memory management in database management systems.

### BACKGROUND OF THE INVENTION

Memory management is a significant issue in many computer systems, including database management systems. Applications that run in a computer system often are allocated resources, such as working memory, on a dynamic basis, based upon the needs of the application during runtime. Likewise, as applications close, or otherwise cease to use their allocated resources, it is often desirable to release these resources so that they can be used by other applications in the computer system.

A dynamic and complex application may access data and distribute work in a multi-tier environment, and may consume a large amount of system resources as dynamic activity increases or decreases. Complex applications such as Enterprise Resource Planning (ERP) applications often have memory management algorithms embedded in the application to manage memory resources. The algorithms monitor activity to actively manage the amount of memory resources that are used. Conventional algorithms manage memory resources based on a relatively simplistic model of tracking objects at the application level and issuing commands to release objects when certain thresholds are reached.

In the case where a database server, or database management system (DBMS) is used by an application, the application may use a single connection or a connection pool to access the database. As the application uses the connection(s) to perform work in the database, the number of open cursors and pseudo-closed cursors can become quite large.

A cursor is generally a control structure used for the successive traversal and processing of records in a result set. A cursor is open when the cursor is currently in use by a connection or session. In contrast, a pseudo-closed cursor is a cursor that is no longer in use, but is still resident in a cursor pool and available to be used by another connection or session. Through the use of a pool of cursors, cursors can be reused to reduce the overhead associated with creating new cursors, and thus increase system performance.

Cursors in a cursor pool consume memory resources, whether open or pseudo-closed, until the cursors are fully closed and removed from memory. Cursors may also hold significant other resources in memory in which they reference. In particular, each cursor typically holds a reference to a database access plan. These access plans are created by the database when queries are first executed, and are used to optimize the execution of the queries by a database engine. In addition, when the numbers of open cursors and pseudo-closed cursors increase to considerable numbers, the amount of memory resources consumed by a cursor pool can become significant. Applications, such as ERP applications, typically monitor the number of pseudo-closed cursors, and when the number reaches a certain threshold, they will issue an API call to fully close a number of the cursors and free up large amounts of memory. Managing cursors at application level, however, can be problematic for a computer system as a whole, however, should an application fail to rigorously manage the size of a cursor pool. Furthermore, a failure of an application may result in the cursor pool used by the application becoming orphaned in the database management system, resulting in the memory resources being unavailable until the database management system is restarted.

Some database management systems provide for rudimentary management of a shared pool of storage for open cursors. The control mechanism is essentially a threshold setting that prevents the caching of cursors above a prescribed level, such as table or schema. The setting is a one size fits all rule, and affects all users to the same degree, and thus lacks flexibility for dealing with different types of applications and different types of workloads.

A need therefore exists in the art for an improved manner for monitoring and managing cursors in a pool of cursors that does not require applications to account for their cursor usage, but that provides sufficient flexibility to address a wide variety of applications and workloads.

### SUMMARY OF THE INVENTION

The invention addresses these and other problems associated with the prior art by providing an apparatus, program product and method that utilize policy-driven management of a pool of cursors in a database management system. Cursor usage statistics are determined for a plurality of cursors, and a plurality of cursor criteria defined in a policy are used to identify one or more cursors to close based upon the determined statistics. Among the statistics that are collected is a query time statistic that specifies, for each cursor, how long the query with which that cursor is associated, took to execute. As a result, a cursor that is associated with query that took a relatively longer time to execute will generally be less likely to be closed than a cursor that is associated with a query that took a relatively shorter time to execute. Consequently, should a cursor be needed for a particular query after the cursor has been closed, the performance penalty associated with recreating that cursor and its associated objects will be reduced.

Consistent with one aspect of the invention, a pool of cursors is managed in a database management system of the type accessed by at least one application. In the database management system, and separate from the application, a plurality of cursor usage statistics is determined for a plurality of cursors in the pool of cursors. A database policy is applied to the plurality of cursors to identify at least one closeable cursor among the plurality of cursors that is suitable for closing, and the at least one identified cursor in response to applying the database policy to the plurality of cursors. Each of the plurality of cursors is associated with a query, and the plurality of cursor usage statistics includes a query time statistic associated with how long the query associated with each of the plurality of cursors took to execute. The plurality of cursor close criteria includes a query time criterion associated with the query time statistic that identifies a first cursor having a shorter query time statistic over a second cursor having a longer query time statistic.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 is a block diagram of a computer system incorporating policy-based cursor pool management consistent with the invention.

FIG. 2 is a flowchart illustrating the program flow of a monitor statistics routine executed by the database management system referenced in FIG. 1.

FIG. 3 is a flowchart illustrating the program flow of an apply policy routine executed by the database management system referenced in FIG. 1.

FIG. 4 is a block diagram of an exemplary cursor management policy used by the database management system referenced in FIG. 1.

### DETAILED DESCRIPTION

Embodiments consistent with the invention implement policy-based management of a pool of cursors utilized by a database management system. A database policy consistent with the invention operates as a cursor management database policy and utilizes an autonomic algorithm that monitors open cursors and pseudo-closed cursors in the system in order to dynamically and autonomically free memory resource in manner which benefits applications and frees memory resources for the database management system. The database policy operates within a database management system, rather than in any application that utilizes the database management system, thus freeing application developers from having to ensure that a cursor pool used by an application is properly managed.

A cursor management database policy consistent with the invention includes a plurality of cursor close criteria that are associated with a plurality of cursor usage statistics tracked by the database management system. The cursor close criteria may be used not only to specify whether or not to close any cursors, but also which among the open and/or pseudo-open cursors should be closed.

The cursor usage statistics may include, for example, a query time statistic that is associated with how long a query associated with a particular cursor took to execute. The query time statistic may be based upon the execution time for the first time the query is executed, in order to take into account the amount of time required to build the access plan and any other objects used by the query and stored with the cursor. The query time statistic effectively predicts the amount of time that would be expended were the associated cursor closed and the query later encountered—i.e., the penalty that would be incurred were the cursor not available were it needed again. Thus, by selecting one cursor that has a relatively small performance penalty due to being associated with a query that takes a relatively short time to execute to close over another cursor associated with a query that takes a longer time to execute, the penalty that would be incurred if the cursor needed to be rebuilt would be reduced. The query time statistic may also include the time for the creation of any in-memory objects referenced by the cursor such as a query access plan.

The cursor usage statistics may also include a staleness statistic that is associated with how long a cursor has been in use. Additional statistics, such as the amount of memory used by open cursors and/or pseudo-open cursors, the total number of open cursors and/or pseudo-open cursors, and the amount of memory consumed by objects referenced by open and/or pseudo-closed cursors, may also be tracked and utilized by a cursor management database policy.

A cursor management database policy can be based on a variety of cursor close criteria that includes, for example, a threshold in relation to the amount of memory used by open cursors or pseudo-closed cursors, a threshold in relation to the total number of open cursors or pseudo-closed cursors, a threshold in relation to the amount of memory consumed by objects referenced by open or pseudo-closed cursors, whether collectively or individually (i.e., a close criteria could be based upon the total memory consumed by objects referenced by all cursors, or could be based on the total memory consumed by objects referenced by a specific cursor), a threshold in relation to the amount of time of the first execution of the query that a cursor represents, which may include the time for the creation of any in-memory objects referenced by the cursor such as a query access plan.

In other embodiments, a more elaborate policy may permit a user to set the type of cursor management database policy based on terms such as aggressive/moderate/conservative for an entire database footprint. Based upon the selection, a database management system may enact an algorithm that is suitable for the semantic type. For instance, an aggressive policy may instruct the database to track system storage related to pseudo-closed cursors and determine when to hard close them based upon system storage capacity and response time. The policy selection may also include threshold settings and values as noted above. It is also noted that scheduled policy changes could benefit performance of the database based on timely events, such as end of quarter processing of data which needs more resource from the system.

In addition, in some embodiments, policy types may be selected for each table or schema within a database. Based upon an individual policy type selection, the enacted algorithm, which may consist of rules based on system storage capacity and response time and/or the thresholds discussed above, may execute with respect to the individual table or schema.

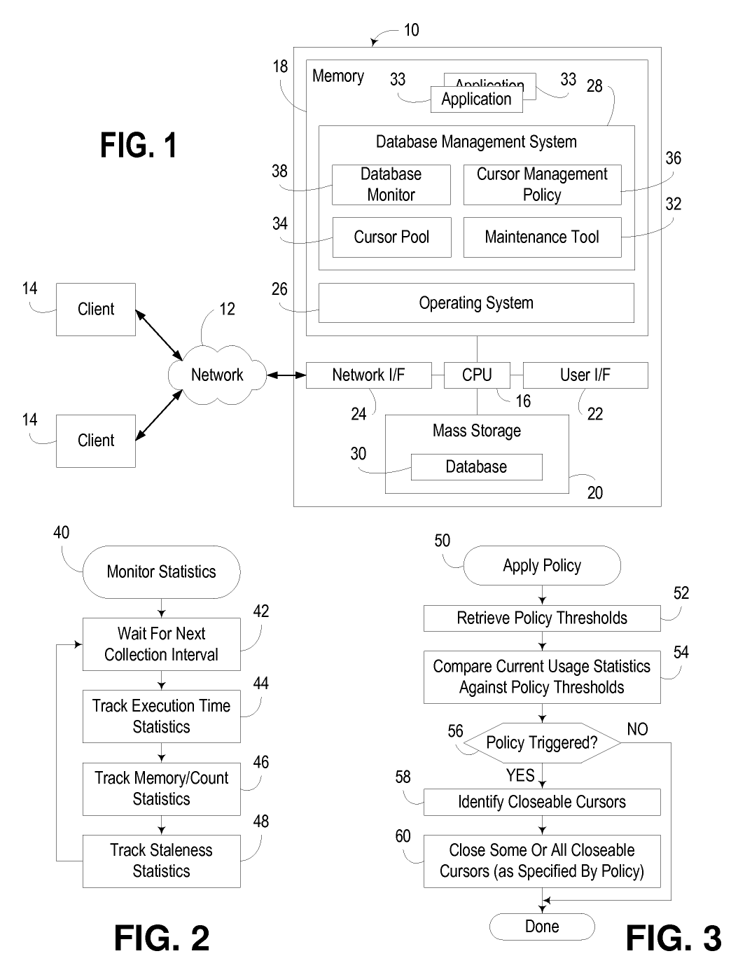

Turning now to the Drawings, wherein like numbers denote like parts throughout the several views, FIG. 1 illustrates an exemplary apparatus 10 within which policy-based cursor pool management may be performed in a manner consistent with the invention. Apparatus 10 in the illustrated embodiment is implemented as a server or multi-user computer that is coupled via a network 12 to one or more client computers 14. For the purposes of the invention, each computer 10, 14 may represent practically any type of computer, computer system or other programmable electronic device. Moreover, each computer 10, 14 may be implemented using one or more networked computers, e.g., in a cluster or other distributed computing system. In the alternative, policy-based cursor pool management consistent with the invention may be implemented within a single computer or other programmable electronic device, e.g., a desktop computer, laptop computer, handheld computer, cell phone, set top box, etc.

Computer 10 typically includes a central processing unit 16 including at least one microprocessor coupled to a memory 18, which may represent the random access memory (RAM) devices comprising the main storage of computer 10, as well as any supplemental levels of memory, e.g., cache memories, non-volatile or backup memories (e.g., programmable or flash memories), read-only memories, etc. In addition, memory 18 may be considered to include memory storage physically located elsewhere in computer 10, e.g., any cache memory in a processor in CPU 16, as well as any storage capacity used as a virtual memory, e.g., as stored on a mass storage device 20 or on another computer coupled to computer 10. Computer 10 also typically receives a number of inputs and outputs for communicating information externally. For interface with a user or operator, computer 10 typically includes a user interface 22 incorporating one or more user input devices (e.g., a keyboard, a mouse, a trackball, a joystick, a touchpad, and/or a microphone, among others) and a display (e.g., a CRT monitor, an LCD display panel, and/or a speaker, among others). Otherwise, user input may be received via another computer or terminal.

For additional storage, computer 10 may also include one or more mass storage devices 20, e.g., a floppy or other removable disk drive, a hard disk drive, a direct access storage device (DASD), an optical drive (e.g., a CD drive, a DVD drive, etc.), and/or a tape drive, among others. Furthermore, computer 10 may include an interface 24 with one or more networks 12 (e.g., a LAN, a WAN, a wireless network, and/or the Internet, among others) to permit the communication of information with other computers and electronic devices. It should be appreciated that computer 10 typically includes suitable analog and/or digital interfaces between CPU 16 and each of components 18, 20, 22 and 24 as is well known in the art. Other hardware environments are contemplated within the context of the invention.

Computer 10 operates under the control of an operating system 26 and executes or otherwise relies upon various computer software applications, components, programs, objects, modules, data structures, etc., as will be described in greater detail below. Moreover, various applications, components, programs, objects, modules, etc. may also execute on one or more processors in another computer coupled to computer 10 via network 12, e.g., in a distributed or client-server computing environment, whereby the processing required to implement the functions of a computer program may be allocated to multiple computers over a network.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to physical, recordable type media such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various program code described hereinafter may be identified based upon the application within which it is implemented in a specific embodiment of the invention. However, it should be appreciated that any particular program nomenclature that follows is used merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the invention is not limited to the specific organization and allocation of program functionality described herein.

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

Policy-based cursor pool management is implemented in the illustrated embodiment in a database management system 28, and in particular, within a maintenance tool 32 therein. Database management system 28 provides user access to one or more databases, e.g., database 20, typically via user requests generated by one or more applications 33. A cursor pool 34 maintains a pool of cursors that are used by applications 33 to access database management system 28. A cursor management policy 36 is used by maintenance tool 32 to manage the cursor pool, and statistics used to monitor the cursor pool are collected by a database monitor 38.

FIG. 2 illustrates a monitor statistics routine 40 capable of being executed by database monitor 38 of FIG. 1. Routine 40 periodically collects and/or updates relevant cursor usage statistics for use by maintenance tool 32 in managing cursor pool 34. Routine 40 therefore begins in block 42 by waiting for a next collection interval. When the next interval is reached, block 44 tracks execution time statistics, e.g., a query time statistic associated with how long a particular query associated with a particular cursor took to execute. Block 46 tracks memory and/or count statistics, e.g., the total amount of memory consumed by the cursor pool, the amount of memory consumed by selected cursors in the cursor pool, the amount of memory consumed by objects referenced by selected cursors, the count of cursors, the count of objects referenced by cursors, the count of pseudo-closed cursors, etc. Block 48 tracks staleness statistics, e.g., the last time a particular cursor was used and/or opened. Control then returns to block 42 to wait for the next collection interval.

It will be appreciated that statistics collection may be performed separate from a database monitor, e.g., in a routine that applies a policy, in a routine that closes cursors, in a routine that runs when a policy is activated, etc. Different statistics may also be collected at different points, e.g., query time statistics may be collected in a routine that creates a cursor and runs a query. Different statistics may also be collected based upon the particular thresholds supported for a cursor management database policy.

FIG. 3 next illustrates an apply policy routine 50 capable of being executed by maintenance tool 32 of FIG. 1. Routine 50 begins in block 52 by retrieving the policy thresholds. Block 54 then compares current usage statistics against the retrieved thresholds. Block 56 determines whether the comparison indicates that the policy has been triggered, and if not, routine 50 is complete. If the policy is triggered, block 58 identifies one or more closeable cursors based upon the usage statistics and the policy parameters. Block 60 then closes some or all of the closeable cursors as specified by the policy, and routine 50 is then complete. The identification of closeable cursors may identify all cursors that are closeable pursuant to the policy, or may only identify enough cursors that can be closed to release a desired amount of memory. The policy may also specify that only enough cursors be closed to reduce the size of the pool to a particular size, or all identified cursors may be closed, irrespective of the expected size of the pool after all such cursors have been closed. It will be appreciated that closeable cursors will typically be pseudo-closed cursors in many embodiments, as open or active cursors that are currently in use generally cannot be closed until they are no longer in use. It will also be appreciated that closing cursors, and freeing the resources used thereby, is a process well understood by those of ordinary skill in the art.

Routine 50 may be run manually by an administrator, or may run autonomically as a background process. The policy could specify an interval that the policy is applied, such that routine 50 is run periodically. If statistics are collected in association with applying the policy, the policy may also specify a length of time to collect statistics before closing. A policy may also apply only to specific tables or schemas in the database, to a particular user or application, or may be universally applied throughout a database management system, whereby routine 50 may be limited to applying a policy to certain portions of the database, or certain applications or users.

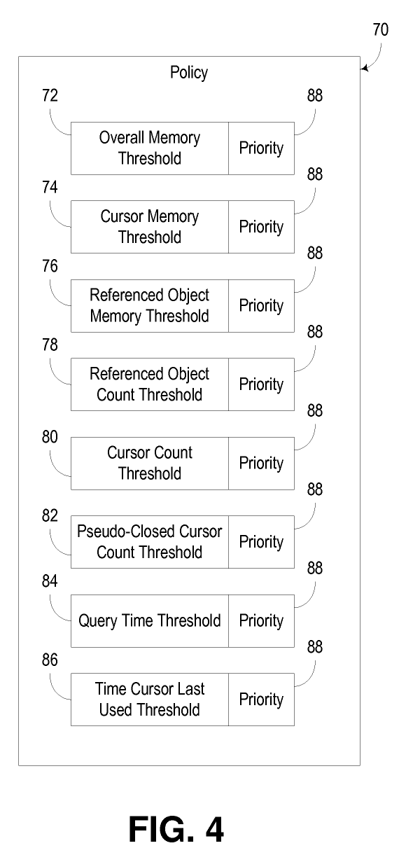

FIG. 4 illustrates an exemplary policy 70 that may be utilized by database management system 28 of FIG. 1. Policy 70, for example, may include an overall memory threshold 72 that represents the total consumed memory for all open and pseudo-closed cursors, with or without referenced objects. Policy 70 may also include a cursor memory threshold 74 that represents the consumed memory for a particular cursor, as well as a referenced object memory threshold 76 that represents the consumed memory for the referenced objects for a particular cursor, or for all cursors in the pool. Policy 70 may also include referenced object count 78, cursor count 80 and pseudo-closed cursor count 82 thresholds, respectively representing the total number of referenced objects, cursors, and pseudo-closed cursors in the pool.

Policy 70 also includes a query time threshold, representing the time that the query associated with a particular cursor took to execute, typically the first time the query was executed, in order to factor the cost of building the query access plan and any other objects referenced by the cursor. Policy 70 may also include a staleness threshold such as a time cursor last used threshold 86, associated with the time a particular cursor was last used.

The thresholds in policy 70 may also be associated with priorities 88, representing an order in which the thresholds are applied. In addition, it may be desirable to associate sets of thresholds with themes such as aggressive, moderate or conservative to simplify management.

In one embodiment, for example, a database management console may provide the means by which a variety of thresholds may be set. When various thresholds are enabled, statistics are collected within the database at opportune times and compared to them. The priority of each threshold may be based dependent on the order they are listed in the console. Based on the priority the algorithm may be used to find all cursors that meet the top priority criteria and then find subsets of those that meet the secondary criteria, etc. Upon final subset selection, an issue of a full-close may be done for each cursor, to allow for the recycle of resources. In the alternative, more complex policies that factor multiple statistics together in determining which cursors may be closed, may be used in the alternative.

In addition, by closing cursors based at least in part on query time, cursors that may take longer to rebuild if needed in the future may be kept in favor of those that would not be as resource intensive to recreate. In addition, it may be desirable to keep cursors that consume more resources for the same reason. Furthermore, it generally would be more desirable to close cursors that have not been used for a comparatively longer period of time.

Using the aforementioned management scheme, for example, an administrator could create a policy that specified that if the number of cursors exceeded 500 or the amount of memory consumed by the cursors in the cursor pool exceeded 500 MB, then close all pseudo-closed cursors having query times under 5 seconds that haven't been run in 4 hours, and all pseudo-closed cursors that have consumed more than 1 MB and haven't been run in 8 hours. It will be appreciated that given the flexibility provided by the aforementioned policy-based cursor pool management technique, an innumerable number of types of policies may be created an applied. The invention is therefore not limited to the particular examples discussed herein.

Various modifications may be made without departing from the spirit and scope of the invention. Therefore, the invention lies in the claims hereinafter appended.

What is claimed is:

1. A method of managing a pool of cursors in a database management system of the type accessed by at least one application, the method comprising, in the database management system and separate from the application:
for a plurality of cursors in the pool of cursors, determining a plurality of cursor usage statistics, wherein each of the plurality of cursors is associated with a query, and wherein the plurality of cursor usage statistics includes a query time statistic associated with how long the query associated with each of the plurality of cursors took to execute;
applying a database policy to the plurality of cursors to identify at least one closeable cursor among the plurality of cursors that is suitable for closing, wherein the database policy includes a plurality of cursor close criteria associated with the plurality of cursor usage statistics, the plurality of cursor close criteria including a query time criterion associated with the query time statistic that identifies a first cursor having a shorter query time statistic over a second cursor having a longer query time statistic; and
closing the at least one identified cursor in response to applying the database policy to the plurality of cursors.

2. The method of claim 1, wherein the plurality of cursor usage statistics additionally includes:
a staleness statistic associated with a time in which a selected cursor was last used;
a first memory usage statistic associated with an amount of memory used by the plurality of cursors;
a second memory usage statistic associated with a number of cached query objects; and
a cursor count statistic associated with a number of pseudo-closed cursors;
wherein applying the database policy identifies the at least one closeable cursor based upon a combination of the query time statistic, the staleness statistic, the first and second memory usage statistics and the cursor count statistic.

3. The method of claim 1, wherein the plurality of cursor usage statistics further includes a memory usage statistic associated with an amount of memory used by at least a portion of the plurality of cursors, and wherein the plurality of cursor close criteria further includes a memory usage criterion associated with the memory usage statistic.

4. The method of claim 3, wherein the memory usage statistic is associated with an amount of memory collectively consumed by the plurality of cursors.

5. The method of claim 3, wherein the memory usage statistic is associated with an amount of memory consumed by selected cursors among the plurality of cursors.

6. The method of claim 3, wherein the memory usage statistic is associated with an amount of memory consumed by objects referenced by selected cursors among the plurality of cursors.

7. The method of claim 1, wherein the plurality of cursor usage statistics further includes a cursor count statistic associated with a number of cursors in the pool of clusters, and wherein the plurality of cursor close criteria further includes a cursor count criterion associated with the cursor count statistic.

8. The method of claim 1, wherein the plurality of cursor usage statistics further includes a memory usage statistic associated with an amount of memory consumed by objects referenced by at least a portion of the plurality of cursors, and wherein the plurality of cursor close criteria further includes a memory usage criterion associated with the memory usage statistic.

9. The method of claim 1, wherein the query time statistic is associated with an amount of time at least one object referenced by a selected cursor took to create.

10. The method of claim 1, wherein the plurality of cursor usage statistics further includes a staleness statistic associated with a time in which a selected cursor was last used, and wherein the plurality of cursor close criteria further includes a staleness criterion associated with the staleness statistic.

11. The method of claim 1, wherein applying the database policy includes applying the plurality of cursor close criteria based upon relative priorities of the plurality of cursor close criteria.

12. The method of claim 1, wherein the plurality of cursors include open and pseudo-closed cursors, and wherein closing the at least one identified cursor includes releasing resources used by the at least one identified cursor.

13. An apparatus, comprising:
at least one processor; and
a database management system configured to execute on the at least one processor to manage a pool of cursors, the database management system configured to, separate from any application that accesses the database management system, determine, for a plurality of cursors in the pool of cursors, a plurality of cursor usage statistics, apply a database policy to the plurality of cursors to identify at least one closeable cursor among the plurality of cursors that is suitable for closing, and close the at least one identified cursor in response to applying the database policy to the plurality of cursors, wherein each of the plurality of cursors is associated with a query, wherein the plurality of cursor usage statistics includes a query time statistic associated with how long the query associated with each of the plurality of cursors took to execute, and wherein the plurality of cursor close criteria includes a query time criterion associated with the query time statistic that identifies a first cursor having a shorter query time statistic over a second cursor having a longer query time statistic.

14. A program product, comprising:
program code configured to execute in a database management system to manage a pool of cursors, the program code configured to, separate from any application that accesses the database management system, determine, for a plurality of cursors in the pool of cursors, a plurality of cursor usage statistics, apply a database policy to the plurality of cursors to identify at least one closeable cursor among the plurality of cursors that is suitable for closing, and close the at least one identified cursor in response to applying the database policy to the plurality of cursors, wherein each of the plurality of cursors is associated with a query, wherein the plurality of cursor usage statistics includes a query time statistic associated with how long the query associated with each of the plurality of cursors took to execute, and wherein the plurality of cursor close criteria includes a query time criterion associated with the query time statistic that identifies a first cursor having a shorter query time statistic over a second cursor having a longer query time statistic; and
a recordable computer readable medium storing the program code.
